(19) United States
(12) Patent Application Publication
(10) Pub. No.: US 2021/0158434 A1
(43) Pub. Date: May 27, 2021

(54) Mobile Power Unit Rental System and Method

(71) Applicant: Zake International Inc., South Bend, IN (US)

(72) Inventor: Jianqing Zhu, South Bend, IN (US)

(73) Assignee: Zake International Inc., South Bend, IN (US)

(21) Appl. No.: 16/695,089

(22) Filed: Nov. 25, 2019

(51) Int. Cl. G06Q 30/06; G06Q 20/18; G06Q 20/08; G06Q 30/02; G06Q 20/20; H04B 1/3827; H02J 7/00

(52) U.S. Cl. CPC G06Q 30/0645; G06Q 20/18; G06Q 20/0855; G06Q 30/0284; G06Q 2220/00; G06Q 20/202; H04B 1/3827; H02J 7/0042; G06Q 20/204

(57) ABSTRACT

The present disclosure relates to systems and methods for renting portable power units (also known as portable chargers) from a terminal, kiosk, machine, or any other physical unit that is capable of autonomously processing (including crediting) rental payments, autonomously distributing one or more power units to a renter subject to such payments, and autonomously facilitating the return of the one or more power units at the same (or a different) related rental terminal, kiosk, machine or unit.

### TECHNICAL FIELD

The present disclosure relates generally to battery chargers for portable devices, and more particularly, but not exclusively, to systems and methods for renting battery chargers for portable electronic devices.

### SUMMARY OF THE INVENTION

Embodiments disclosed herein provide a power unit rental system and methods that may include a rental terminal, the rental terminal may include at least one mobile power unit for use in charging an electronic device, wherein the rental terminal is configured to accept payment information for a rental of the at least one mobile power unit, and wherein upon dispensing the at least one mobile power unit to a renter, the rental terminal is configured to monitor an amount of time for which the mobile power unit is rented and cause one or more payments for the rental to be completed or credited based on the amount of time for which the mobile power unit is rented. The rental system may further include one or more servers coupled to the rental terminal, wherein at least one of the one or more servers is configured to use the payment information to authorize the one or more payments for the rental to be completed or credited. The at least one of the one or more servers may be a first server that is configured to use the payment information to authorize the one or more payments using an application program interface, where another of the one or more servers is a second server that communicates the payment information to the first server via the application program interface that may reside on the first server. A control processing unit of the rental terminal may be configured to cause the one or more payments for the rental to be completed or credited based on the amount of time for which the mobile power unit is rented by sending the payment information from the rental terminal to the first server via the second server. The control processing unit of the rental terminal may also be configured to dispense a mobile power unit to a renter when payment is authorized, create an account associated with the renter, encrypt the renter's payment information, store the encrypted payment information in a memory of the data storage unit, retrieve the encrypted payment information from the memory, decrypt the payment information to cause one or more payments for the rental to be completed or credited, and delete a renter's account when a rental is complete.

Embodiments of the present disclosure may include a computer readable medium that is non-transitory and may store instructions for performing the above-described functionality. For example, a computer readable medium may store instructions to be executed by the control processing unit to accept payment information for a rental of the at least one mobile power unit, dispensing the at least one mobile power unit to a renter, monitor an amount of time for which the mobile power unit is rented and cause one or more payments for the rental to be completed or credited based on the amount of time for which the mobile power unit is rented. In another example, a computer readable medium may store instructions to be executed by the control processing unit of the rental terminal to cause the one or more payments for the rental to be completed or credited based on the amount of time for which the mobile power unit is rented by sending the payment information from the rental terminal to the first server via the second server. In a further example, a computer readable medium may also store instructions to be executed by the control processing unit of the rental terminal to dispense a mobile power unit to a renter when payment is authorized, create an account associated with the renter, encrypt the renter's payment information, store the encrypted payment information in a memory of the data storage unit, retrieve the encrypted payment information from the memory, decrypt the payment information to cause one or more payments for the rental to be completed or credited, or delete a renter's account when a rental is complete.

The foregoing has outlined rather broadly pertinent and important features of the present disclosure so that the detailed description of the invention that follows may be better understood and so that the present contribution to the art can be more fully appreciated. Additional features of the invention will be described hereinafter that form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE DRAWINGS

The written disclosure herein describes illustrative embodiments that are non-limiting and non-exhaustive. Reference is made to certain illustrative embodiments that are depicted in the figures, in which:

FIG. 1 illustrates a schematic diagram of an exemplary mobile power unit rental system consistent with embodiments of the present disclosure;

FIG. 2 illustrates a schematic diagram of an exemplary mobile power unit rental terminal consistent with embodiments of the present disclosure;

FIG. 3 illustrates a front-view block diagram of an exemplary mobile power unit rental terminal consistent with embodiments of the present disclosure;

FIG. 4 illustrates a schematic diagram of an exemplary operation of inserting a mobile power unit into a storage unit of a rental terminal consistent with embodiments of the present disclosure;

FIG. 5 illustrates a schematic diagram of an exemplary operation of dispensing a mobile power unit from a storage unit of a rental terminal consistent with embodiments of the present disclosure;

FIG. 6 illustrates an exemplary mobile power unit rental method consistent with embodiments of the present disclosure; and

FIG. 7 illustrates an exemplary mobile power unit rental method consistent with embodiments of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications and equivalents. In addition, while numerous specific details are set forth in the following description to provide a thorough understanding of the embodiments disclosed herein, some embodiments can be practiced without some or all of these details. Moreover, for the purposes of clarity, certain material that is known in the related art has not been described in detail to avoid unnecessarily obscuring the disclosure.

The description may use the terms “embodiment” or “embodiments,” which may each refer to one or more of the same or different embodiments. The terms “comprising,” “including,” “having,” and the like, as used with respect to embodiments, are synonymous, and are generally intended as “open” terms—e.g., the term “includes” should be interpreted as “includes but is not limited to,” the term “including” should be interpreted as “including but not limited to,” and the term “having” should be interpreted as “having at least.” Unless otherwise defined, all technical terms used herein have the same meaning as commonly understood by one of ordinary skill in the art to which this disclosure belongs. As used herein, the term “approximately” refers to an amount that is near the stated amount by 0%, 5%, or 10%, including increments therein.

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, ¶6.

Regarding the use of any plural and/or singular terms herein, those of skill in the relevant art can translate from the plural to singular and/or from the singular to the plural as is appropriate to the context and/or application. The various singular and/or plural permutations may be expressly set forth herein for the sake of clarity. The embodiments of the disclosure may be understood by reference to the drawings, wherein like parts may be designated by like numerals. The elements of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure. In addition, the steps of any method disclosed herein do not necessarily need to be executed in any specific order, or even sequentially, nor need the steps be executed only once, unless otherwise specified.

Portable electronic devices are ubiquitous and may include, without limitation, mobile devices such as smartphones, tablets, computers, or any other device that can be carried and operates using electrical energy. Mobile devices, for example, make and receive phone calls, send and receive e-mail, connect to the Internet, record and play audio visual media, provide word processing capabilities, and so on. Thus, the batteries of such devices must be repeatedly charged. Embodiments disclosed herein reduce the inconvenience of charging one's mobile device or any other portable device, especially in circumstances where a portable device user does not have access to charging stations, portable chargers, electrical sockets, and the like.

In particular, embodiments disclosed herein provide for systems and methods for renting portable power units (also known as portable chargers) from a terminal, kiosk, machine, or any other physical unit that is capable of autonomously processing rental payments in a manner that does not require payment processing systems such as point of sale (POS) systems and the like, autonomously distributing one or more power units to a renter upon such payment, and autonomously facilitating the return of the one or more power units at the same (or a different) related rental terminal, kiosk, machine or unit.

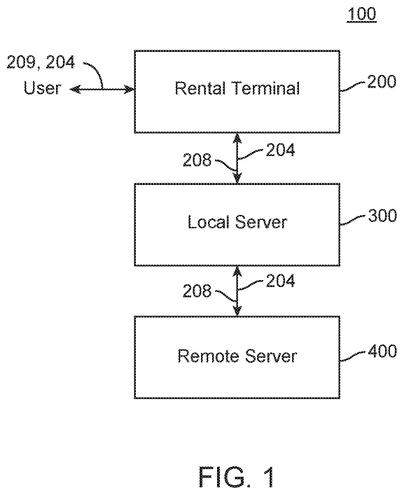

FIG. 1 illustrates a mobile power unit rental system 100 consistent with one embodiment of the present disclosure. The mobile power unit rental system 100 may include a rental terminal 200 that may be physically and/or electronically (including wirelessly) coupled to one or more servers 300. In one embodiment, at least one of the servers 300 may be local. The system 100 may further include one or more servers 400 that may be physically and/or electronically (including wirelessly) coupled to the one or more servers 300. In one embodiment, at least one of the servers 400 may be remote. A server 300, 400 may comprise a virtual computer, dedicated physical computing device, shared physical computer or computers, or computer service daemon. A server 300, 400 may also comprise one or more processors such as central processing units (CPUs), natural language processor (NLP) units, graphics processing units (GPUs), and/or one or more artificial intelligence (AI) chips, for example. In some embodiments, a server 300, 400 may be a high-performance computing (HPC) server (or any other maximum performance server) capable of accelerated computing. In some embodiments, a server 300, 400 may be a cloud-based server.

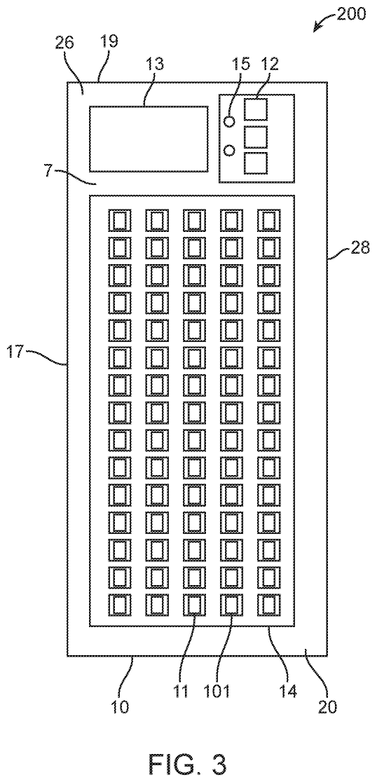

Consistent with embodiments of the present disclosure, a renter may rent one or more mobile power units 101 (not shown) from a rental terminal 200. In one embodiment, the rental terminal 200 may be configured to receive one or more requests 209 from a renter, and perform operations in response to the one or more renter requests 209. For example, in one embodiment, the rental terminal 200 may receive a renter's request 209 to rent a mobile power unit 101. In response to the renter's request 209, the rental terminal 200 may retrieve a payment 204 from the renter and, subject to the payment authorization, dispense a mobile power unit 101 to the renter. Similarly, in response to a renter request 209 to return a rented mobile power unit 101, the rental terminal 200 may retrieve a rented mobile power unit 101 from the renter, and store (and recharge) the mobile power unit 101 in the rental terminal 200 for future rentals. In one embodiment, a user screen 13 (FIG. 3) and/or indicator unit 15 light (FIG. 3) of the rental terminal may be used to notify a renter that the mobile power unit has been returned successfully.

In one embodiment, a rental terminal 200 may be configured receive payment information 204 from a renter, confirm that the payment information 204 includes information that may be needed to authorize the payment, and send such payment data 204 to a server 300, which in turn, sends the payment information 204 to a server 400 that is capable of authorizing the renter's payment. In the case where the renter's payment 204 is made by credit card, payment data 204 may include, without limitation, a renter's credit card number and/or expiration date. Or, in the case where the renter' payment 204 is made by a mobile terminal application, payment data 204 may include, without limitation, a renter's credit card, application registered, and/or login information. In one embodiment, an application program interface (API) of the server 400 may be configured to receive data from (and transmit data to) a server 300, including payment data 204 (as discussed above) and message data 208 (as discussed below). By using an API (or similar technology) to handle payment authorizations between a server 300 and server 400, the need for costly payment processing technology such as point-of-sale (POS) technology, and the like, may be avoided. This approach may also reduce the overall manufacturing and operational costs associated with a rental terminal 200.

In one embodiment, if a payment is approved, a server 400 may send a message 208 to a server 300 notifying the server 300 that the payment has been approved. Once the message 208 is received by the server 300, the server 300 may send the message 208 (or any other notification) to the rental terminal 200 notifying the rental terminal 200 that the payment 204 has been approved. In this case, as discussed above, the rental terminal 200 may dispense a mobile power unit 101 to the renter and create an account for the renter, which includes the renter's encrypted payment information (e.g., credit card number, billing zip code, credit card expiration date, points, security code, and the like). The encrypted payment information may de-crypted by the rental terminal 200 and used to pay for extending the rental time of the mobile power unit 101, or crediting the renter for a shorter than expected rental. On the other hand, if a payment has been declined, the server 400 may send a message 208 to a server 300 notifying the server 300 that the payment has been declined. Once the message 208 is received by the server 300, the server 300 may send the message 208 (or any other notification) to the rental terminal 200 notifying the rental terminal 200 that the payment has been declined. In this case, the rental terminal 200 will not dispense a mobile power unit 101 to a renter, and may notify the renter that its payment 204 has been declined via a display screen 13 (FIG. 3) of indicator light 15 (FIG. 3).

It is important to note, however, that different configurations of the system 100 are possible consistent with embodiments of the present disclosure. For example, in one embodiment, a server 300 may be capable of authorizing a renter's payment 204; in this case, a server 400 is unnecessary, and any payment authorizations may be handled between a rental terminal 200 and a server 300, which functions as an authorization server.

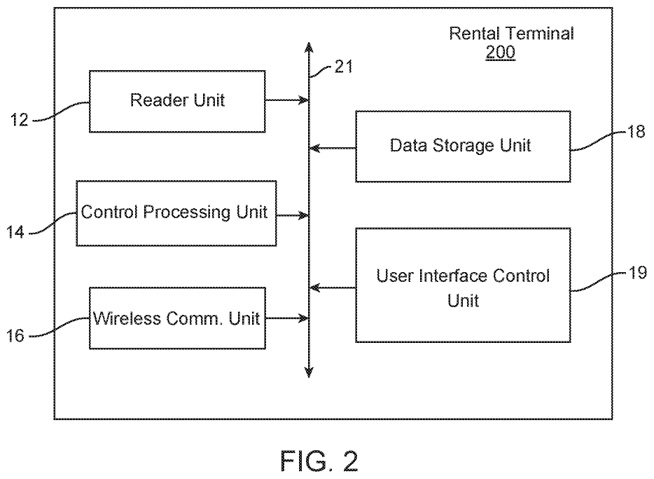

Turning now to FIG. 2, an exemplary rental terminal 200 may comprise a reader unit 12, a control processing unit 14, a data storage unit 18, user interface control unit 19, and a wireless communication unit 16, all or some of which may be physically connected and/or electronically connected via a communication bus 21. The reader unit 12 may comprise a magnetic strip reader or card swipe machine, near-field communication (NFC) chip, two-dimensional barcode scanner, radio-frequency ID (RFID) tag, proximity wireless communication reader, and the like, or any combination thereof. In one embodiment, all or portions of the reader unit 12 may be installed at an outer surface of a rental terminal 200 (FIG. 3). In one embodiment, the reader unit 12 may be physically and/or electronically connected a control processing unit 14 to facilitate, among other things, the collection and/or processing of customer payment information 204.

In one embodiment, a control processing unit 14 may be configured to execute operating system (OS) software and/or application software, which carries out the functions of a rental terminal 200. Such OS software and/or application software may be stored in a data storage unit 18 that is physically and/or electronically connected to a control processing unit 14 via a communication bus 21. In some embodiments, a control processing unit 14 may comprise a CPU (Central Processing Unit), MCU (Micro Control Unit), or the like.

In one embodiment, a user interface control unit 19 may be physically and/or electronically connected to a control processing unit 14 via a communication bus 21. The user interface control unit 19 may be configured to, among other things, notify a renter about whether a payment has been approved or declined, or whether the payment mechanism provided by the renter could be read by the reader unit 12. The user interface control unit 19 may comprise one or more of the following: indicator lights, display screens, speakers (for audio communication), touch screen, keyboard, key pad, and/or any other method of communicating information to (or interacting with) a renter. For example, the exemplary rental terminal 200 shown in FIG. 3 illustrates a user interface control unit 19 that comprises a display/touch screen 13 and indicator lights 15. It is important to note, however, that the user interface control unit 19 may be implemented using other configurations consistent with embodiments of the present disclosure.

In one embodiment, as shown in FIG. 2, a wireless communication unit 16 may be configured to facilitate wireless communication between a rental terminal 200 and a server 300. Such communication may be necessary for authorizing payments, communicating the results of a payment authorization, and like. In one embodiment, the wireless communication unit 16 may also be configured to facilitate communication between a rental terminal 200 and a renter's device such as a mobile phone, tablet, or the like (not shown). Such communication may be necessary when near-field communication (NFC) chip, two-dimensional barcode or quick response (QR) scanner, radio-frequency ID (RFID) tag, proximity wireless communication reader, and the like are being used. The wireless communication unit 16 may be a Bluetooth® module, a wireless fidelity (WiFi) module, or a radio frequency module, or the like. For example, in the case were the wireless communication unit 16 is a Wi-Fi module, the wireless communication unit 16 may connect to a communication interface that is electrically connected to a control processing unit 14. In this case, the communication interface may be a serial peripheral interface (SPI), an inter-integrated circuit (I2C), an asynchronous transceiver (e.g., universal asynchronous receiver/transmitter (UART, etc.), or any other inter-chip communication interface. The communication interface may also be a universal serial bus (USB) interface, a network port, or the like. It is important to note, however, that the present disclosure is not limited to a particular types of communication protocols or interfaces.

In one embodiment, as shown in FIG. 2, a data storage unit 18 of a rental terminal 200 may include a memory, which may be used for storing data and/or one or more programs that the control processing unit 14 can invoke (or use) to perform the various functions described herein via a communication bus 19. In some embodiments, the data storage unit 18 may be a cloud-based data storage unit.

Turning now to FIG. 3, an exemplary rental terminal 200 may comprise a body 10, which in turn may comprise an interior area 7 that is bound by a front door panel 26, a back wall (not shown) opposite the front door panel 26, a side wall 17 opposite a side wall 28, and a top wall 19 opposite a bottom wall 20. The interior area 7 may comprise one or more storage units 11, where each storage unit 11 may be configured to store at least one mobile power unit 101. In one embodiment, each storage unit 11 may include a mechanism for locking or holding a power unit 101, as well as a mechanism for charging a power unit 101. In one embodiment, the storage units 11 may be arranged in an array, as illustrated in FIG. 3, or in any other arrangement. In one embodiment, the body 10 may comprise, steel, fiberglass, glass, and/or plastic, or any other material suitable for constructing a body 10. In one embodiment, the rental terminal 200 may further include a display screen 13 outside the locker body 10 that may be electrically or physically connected to a control processing unit 14 for interacting with a renter. In one embodiment, the rental terminal 200 may further include an indicating unit 15 outside the locker body 10 that may be electrically connected a control processing unit 14 for alerting the renter. For example, an indicating unit 15 may provide audible (e.g., beep, etc.), and/or visual (e.g., light, etc.) alerts to a renter. The rental terminal 200 may also include a reader unit 12 for receiving payment information 204 from a renter, as discussed above with respect to FIG. 2. The rental terminal 200 may include a control processing unit 14 that performs the functions of the rental terminal 200, as discussed with respect to FIG. 2. It is important to note, however, that other rental terminal 200 configurations are possible consistent with embodiments of the present disclosure, including different shape and/or layouts, or the like.

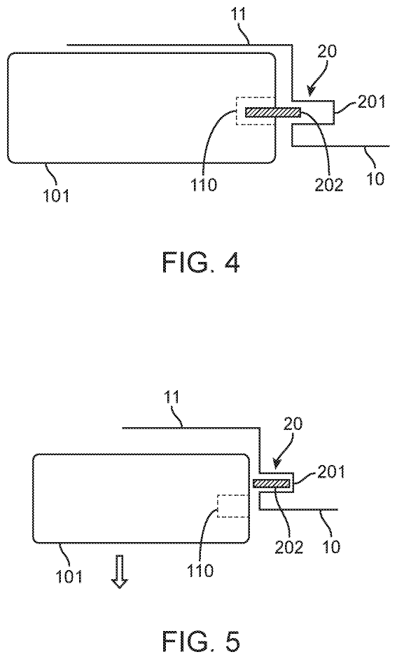

As shown in FIGS. 4 and 5, each storage unit 11 may comprise a locking mechanism 20 and/or a charging mechanism (not shown). In one embodiment, the charging mechanism (not shown) may charge a mobile power unit 101 while it is stored in its storage unit 11, without operator intervention. The charging mechanism may also include a positive pole and a negative pole to charge a power unit 101. In one embodiment, the locking mechanism 20 may hold and release a mobile power unit 101 from a storage until 11 based on commands received from a control processing unit 14. In one embodiment, the locking mechanism 20 of a storage unit 11 may comprise a solenoid valve device, a servo motor device, a locking device, an electromagnet device, a door panel device, and/or any combination thereof to dispense a mobile power unit 101 from (and return a mobile power unit 101 to) a rental terminal 200. Here, it is worth noting that in one embodiment, a renter may select the type of power unit 101 it wishes to rent based upon the particular power configuration requirements needed. Additionally, a locking mechanism 20 may comprise a recess 201 disposed in the locker body 10 of a rental terminal 200, a lock cylinder 202, and the mobile power unit 101 can include a recess 110 corresponding to the recess 201. The lock cylinder 202 may be configured to move linearly through a solenoid valve device (or the like) such that when the lock cylinder 202 extends into the recess 110 of the mobile power unit 101, the mobile power unit 101 can be locked in the body 10 of a rental terminal 200. As shown in FIG. 5, when the lock cylinder 202 is separated from the recess 110 and protrudes into the recess 201, the mobile power unit 101 can be unlocked so that it can be removed from the rental terminal 200. It is important to note, however, that other configurations for locking and/or dispensing mobile power unit 101 are possible consistent with embodiments of the present disclosure.

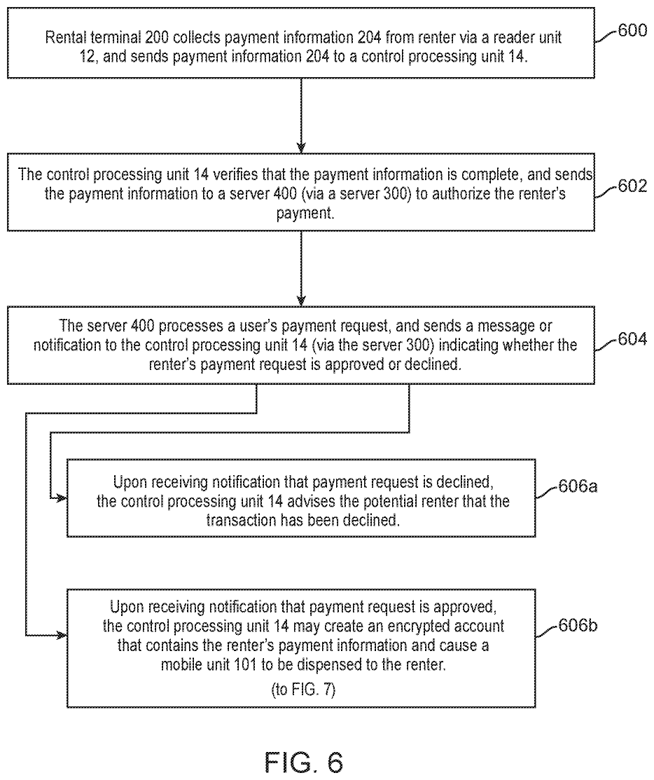

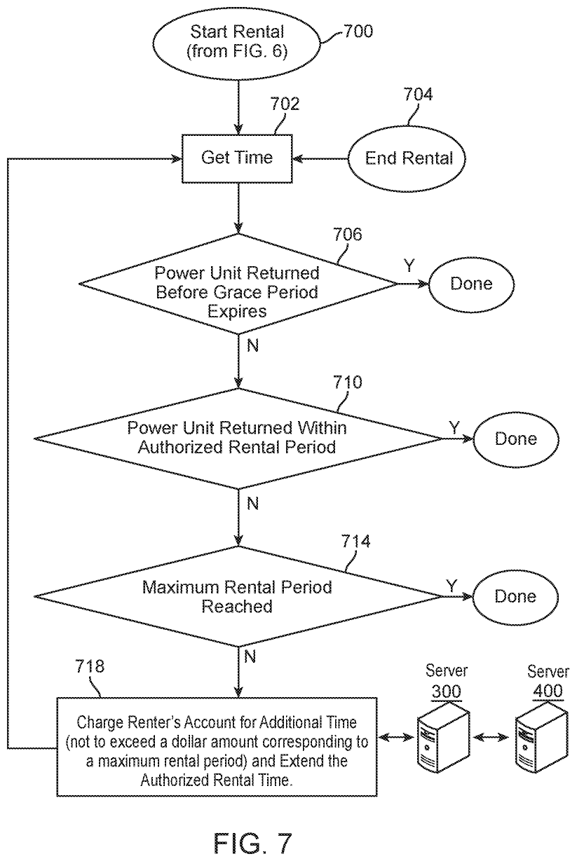

In FIG. 6, an exemplary mobile power unit rental method is described consistent with embodiments of the present disclosure. At 600, a reader unit 12 of a rental terminal 200 may collect payment information 204 from a renter, and sends the payment information 204 to the control processing unit 14 or to a memory of a data storage unit 18 where the control processing unit 14 can retrieve it. In one embodiment, if a reader unit 12 successfully reads the payment information, a green indicator light of the reader unit 12 may be displayed to the renter. Conversely, if a reader unit 12 could not successfully read the renter's payment information, a red indicator light of the reader unit 12 may be displayed to a renter.

At 602, in one embodiment, the control processing unit 14 verifies that the customer payment information 204 is complete and sends the payment information 204 (via a server 300) to a server 400 for payment authorization. For example, the control processing unit 14 may verify that the payment information 204 includes at least: (i) a valid payment method (e.g., credit card number, account number, etc.), and (ii) any other information that is necessary to authorize a payment (e.g., card verification code, card expiration date, available points, billing zip code, passcode, etc.). In one embodiment, the control processing unit 14 may then send this verified payment information 204 to a server 400 (via a server 300) with a request that the server 400 charge the renter for a predetermined dollar amount that corresponds to an authorized rental period (e.g., 40 minutes). In one embodiment, the control processing unit 14 may also request that the server 400 place on hold on (but not charge) the renter's account for a dollar amount equal to the replacement value of a mobile power unit 101. Such a hold may be used to accommodate a situation where the mobile power unit 101 is not returned. So, for example, if the replacement value of the mobile power unit 101 is $120, the control processing unit 14 may request that a server 400 place a hold on the renter's account for $120.

At 604, the server 400 processes a renter's payment request, and sends a message or notification back to the control processing unit 14 (via the server 300) indicating whether the renter's payment request is approved or declined.

At 606a, upon receiving a message or notification from the server 400 that the potential renter's transaction is declined, the control processing unit 14 may advise the renter that a transaction was declined via a user interface control unit 19.

At 606b, upon receiving an approval notification from a server 400, the control processing unit 14 may create an account associated with a renter, encrypt the renter's payment information 204, store the encrypted payment information 204 in a data storage unit 18, and dispense at least one mobile power unit 101 to the renter. At this point, as further illustrated in FIG. 7 below, the control processor unit 14 begins to monitor when (and whether) the power unit 101 is returned, and charges or credits the renter accordingly.

In FIG. 7, an exemplary mobile power unit rental method is described consistent with embodiments of the present disclosure. At 700, once the renter's payment is authorized, a control processing unit 14 of the rental terminal 200 may cause a mobile power unit 101 to be dispensed to a renter. In one embodiment, an authorized rental period and its associated cost may both be predetermined by a control processing unit 14 of the rental terminal 200. For example, purposes of illustration only, a 60-min rental (authorized rental period) may cost $20 (authorized payment). In one embodiment, an authorized rental period may be selected by a renter. Using the illustrative example provided immediately above, the renter may select a 2-hour rental (authorized rental period), in which case, the renter is charged $40 (authorized payment).

At 702, once the mobile power unit 101 is dispensed to a renter, the control processing unit 14 of the rental terminal 200 may record the time at which the mobile power unit 101 was dispensed or account for the current time generally.

At 706, a renter is allowed a pre-determined amount of time (grace period) in which to change its mind and return (at 704) the mobile power unit 101 to the rental terminal 200 without any charge. In this case, the control unit 14 of the rental terminal 200 may compare the time at which the mobile power unit 101 was dispensed to the time at which the mobile power unit 101 was returned (at 704). If the difference between these two times is less than or equal to the grace period, the control processing unit 14 may credit the renter's account for the amount of the authorized payment. For example, using the illustrative example above, assume the renter is charged $20 (authorized payment) for a 60-minute rental period (authorized rental period), and the predetermined grace period is 5 minutes. If the renter returns the mobile power unit 101 back to the rental terminal 200 within 3 minutes, then the control processing unit 14 may access the renter's account, de-crypt the renter's payment information 204, and send a message to a server 400 (via a server 300) identifying the renter's payment information 204 with a request that the renter be credited the previously authorized payment of $20. Here, in one embodiment, the control processing unit 14 of the rental terminal 200 may cause a user interface control unit 19 of the rental terminal 200 to display a message to the renter via a display screen 13 of the rental terminal 200 notifying the renter that their account has been credited. At this point, the control processing unit 14 may also delete the renter's account.

At 710, where a renter has not returned the mobile power unit 101 within a predefined grace period, the control processing unit 14 of the rental terminal 200 may further determine whether the power unit 101 has been returned (at 704) within the authorized rental period. In this case, the control unit 14 of the rental terminal 200 may use current time (at 702), the time at which the mobile power unit 101 was dispensed, the authorized rental period, and the time (if any) at which the mobile power unit 101 was returned (at 704), to determine whether a power unit 101 was returned within the authorized time limit. If the mobile power unit 101 was returned before the authorized time limit, the renter's account may be credited and/or deleted in the same manner as discussed above with respect to step 706. If the mobile power unit 101 was returned at the authorized time limit, then the renter's account will not be credited, but the renter's account may be deleted.

If the mobile power unit 101 has not been returned within the authorized time limit, the control processing unit 14 will further check the status of the rental at step 714. For example, using the illustrative example above, assume the renter is charged $20 (authorized payment) for a 60-minute rental period (authorized rental period). The control processing unit 14 may add 60 minutes (the authorized rental period) to the time a mobile power unit 101 was dispensed to determine a time that the mobile power unit 101 was due for return. If the mobile power unit 101 was returned (at 704) before the time that the mobile power unit 101 was due for return, the control processing unit 14 may credit and delete the renter's account in the same manner as discussed above with respect to step 706. If the mobile power unit 101 was returned (at 704) at the time the mobile power unit 101 was due for return, the renter's account will not be credited. Again, at this point, the renter's account may be deleted.

At 714, if the mobile power unit 101 was not returned within the time that it was due for return, then the control processing unit 14 of the rental terminal 200 may check whether a maximum rental period has been reached before adding additional charges to the renter's account. In one embodiment, the maximum rental period may be determined based on the replacement cost of a mobile power unit 101. For example, using the illustrative example above, where the cost to rent a mobile power unit 101 is $20 per 60 minutes and the replacement value of a mobile power unit 101 is $120, the maximum rental period is reached after 360 minutes (or 6 hours). In one embodiment, as illustrated in FIG. 7, if the maximum rental period has been reached, the control processing unit 14 may assume that the renter does not intend to return the mobile power unit 101 and will stop charging the renter for the mobile power unit 101. The renter, however, may still have the option of returning the mobile power unit 101 via mail or some other delivery service using an address that may be printed on the mobile power unit 101.

If, on the other hand, the maximum rental period has not been reached and the renter has not returned the mobile device unit 101 within the authorized rental period, at 718, the renter may be charged for an additional authorized rental period. Using the illustrative example above, the renter would be charged an additional $20 for an additional 60 minutes, and the authorized rental period is extended by 60 minutes to 120 minutes, and so on.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein but may be modified within the scope of equivalents of the disclosed embodiments.

1. A mobile power unit rental system comprising:
a rental terminal, the rental terminal comprising at least one mobile power unit for use in charging an electronic device, wherein the rental terminal is configured to accept payment information for a rental of the at least one mobile power unit, and wherein upon dispensing the at least one mobile power unit to a renter, the rental terminal is configured to monitor an amount of time for which the mobile power unit is rented, the rental terminal is configured to cause one or more payments for the rental to be completed based on the amount of time for which the mobile power unit is rented, the rental terminal is configured to cause the one or more payments for the rental to be credited based on the amount of time for which the mobile power unit is rented, and the rental terminal is configured to cause an account associated with the renter to be deleted after the one or more payments are credited; and
one or more servers coupled to the rental terminal, wherein at least one of the one or more servers is configured to use the payment information to authorize the one or more payments for the rental to be completed or credited.

2. The mobile power unit rental system of claim 1, wherein the at least one of the one or more servers configured to use the payment information to authorize the one or more payments for the rental is a first server that comprises an application program interface, and wherein another of the one or more servers is a second server that communicates with the first server via the application program interface.

3. The mobile power unit rental system of claim 2, wherein causing the one or more payments for the rental to be completed or credited based on the amount of time for which the mobile power unit is rented comprises sending the payment information from the rental terminal to the first server via the second server, and wherein the second server is a local server.

4. The mobile power unit rental system of claim 1, wherein the rental terminal comprises a reader unit, a control processing unit, a wireless communication unit, a data storage unit, and a user interface control unit, and wherein the reader unit, the control processing unit, the wireless communication unit, the data storage unit and the user interface control unit are coupled via a communication bus.

5. The mobile power unit rental system of claim 4, wherein the control processing unit of the rental terminal is configured to accept the payment information via the reader unit.

6. The mobile power unit rental system of claim 4, wherein the reader unit is selected from a group consisting of a magnetic strip reader, a near-field communication (NFC) chip, a two-dimensional barcode scanner, a radio-frequency ID (RFID) tag, or a proximity wireless communication reader.

7. The mobile power unit rental system of claim 4, wherein the control processing unit of the rental terminal is configured to communicate with the one or more servers via the wireless communication unit.

8. The mobile power unit system of claim 4, wherein the control processing unit is configured to display information to the renter via the user interface control unit.

9. The mobile power unit rental system of claim 4, wherein the control processing unit of the rental terminal is configured to create the account associated with the renter, encrypt the renter's payment information, store the encrypted payment information in a memory of the data storage unit, retrieve the encrypted payment information from the memory, decrypt the payment information to cause one or more payments for the rental to be completed or credited, or delete the encrypted payment information from the memory.

10. The mobile power unit rental system of claim 4, wherein the wireless communication unit is selected from a group consisting of a Bluetooth® module, a wireless fidelity (Wifi) module, or a radio frequency (RF) module.

11. The mobile power unit rental system of claim 1, wherein the payment information comprises a credit card number and a credit card expiration date.

12. The mobile power unit rental system of claim 1, wherein the at least one of the one or more servers configured to use the payment information to authorize the one or more payments for the rental is a local server.

13. The mobile power unit rental system of claim 1, where the rental terminal further comprises a body, the body comprising an interior area that is bound by a front door panel, a back wall opposite the front door panel 26, a left-side wall opposite a right-side wall, and a top wall opposite a bottom wall.

14. The mobile power unit rental system of claim 13, wherein the interior area comprises one or more storage units, and wherein at least one of the one or more storage units is configured to store the least one mobile power unit.

15. The mobile power unit rental system of claim 14, wherein the at least one of the one or more storage units comprises a mechanism for locking or holding the mobile power unit and/or a mechanism for charging the mobile power unit.

16. A method of renting a mobile power unit, comprising:
providing a rental terminal, the rental terminal comprising at least one mobile power unit for use in charging an electronic device, wherein the rental terminal is configured to accept payment information for a rental of the at least one mobile power unit, and wherein upon dispensing the at least one mobile power unit to a renter, the rental terminal is configured to monitor an amount of time for which the mobile power unit is rented, the rental terminal is configured to cause one or more payments for the rental to be completed based on the amount of time for which the mobile power unit is rented, the rental terminal is configured to cause the one or more payments for the rental to be credited based on the amount of time for which the mobile power unit is rented, and the rental terminal is configured to cause an account associated with the renter to be deleted after the one or more payments are credited; and
providing one or more servers coupled to the rental terminal, wherein at least one of the one or more servers is configured to use the payment information to authorize the one or more payments for the rental to be completed or credited.

17. The method of claim 16, further comprising configuring the at least one of the one or more servers to use the payment information to authorize the one or more payments for the rental as a first server that comprises an application program interface, providing another one of the one or more servers as a second server, and using the application program interface to communicate between the first server and the second server.

18. The method of claim 17, further comprising sending the payment information from the rental terminal to the first server via the second server to cause the one or more payments for the rental to be completed or credited based on the amount of time for which the mobile power unit is rented.

19. The method of claim 16, further comprising providing a control processing unit of the rental terminal that is configured to create the account associated with the renter, encrypt the renter's payment information, store the encrypted payment information in a memory of a data storage unit associated with the account, retrieve the encrypted payment information from the memory, decrypt the payment information to cause the one or more payments for the rental to be completed or credited, or delete the account from the memory.
